(19) United States
(12) Patent Application Publication
(10) Pub. No.: US 2008/0316986 A1
(43) Pub. Date: Dec. 25, 2008

(54) Remote Antenna for Wireless Access Point

(75) Inventor: Robert J. Snyder, Westford, MA (US)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 12/160,897

(22) PCT Filed: Jan. 11, 2007
(86) PCT No.: PCT/US07/60363

§ 371 Date: Jul. 15, 2008

Related U.S. Application Data
(60) Provisional application No. 60/763,591, filed on Jan. 31, 2006.

(51) Int. Cl. H04Q 7/24

(52) U.S. Cl. 370/338

(57) ABSTRACT

A center access point (34) is connected to a wired local network. One or more remote access points (36, 38) communicate with the center access point (34) via associated cables (62, 64, 66, 68). A plurality of mobile wireless units (12₁, 12₂, . . . , 12ₙ) is located within an access point network (14) of the wireless local area network (10), each mobile wireless unit (12₁, 12₂, . . . , 12ₙ) is configured to transceive with at least one of the center access point and one of the remote access points (36, 38).

The following relates to the communications arts. It finds particular application in wireless local area network systems (WLAN) and will be described with particular reference thereto. However, the following may also find application in other communications systems.

WLAN is a flexible data communication system that can be implemented as an extension to, or as an alternative for, a wired local area network (LAN). Typically, WLAN uses radio frequency (RF) technology to transmit and receive data over the air without relying on any physical connection. The data being transmitted is superimposed on the radio carrier so that it can be accurately extracted at the receiving end. Multiple radio carriers exist in the same space at the same time without interfering with each other, provided that the radio waves are transmitted on different radio frequencies. To extract data, a radio receiver tunes in one frequency while rejecting all other frequencies.

In a typical WLAN system, an access point station, which includes a receiver/transmitter device or an access point, connects to the wired network from a fixed location using standard cabling. Typically, the access point receives, buffers, and transmits data between the WLAN and the wired network infrastructure. Generally, a single access point supports a small group of users and can function in a range of approximately ten to fifteen meters.

Wireless mobile patient monitoring devices typically communicate by radio frequency signals with the access points which convert the radio frequency signals into appropriate format for transmission on wires. Each access point is connected by a line with a wired local area network and thence to a data processing station. Like a cell phone, each mobile monitoring device registers with one of the access points establishing two-way communications. The access point typically registers mobile monitoring devices and receives in response the latest monitored patient data.

While such systems work well, there are some drawbacks. Generally, in a large facility such as a hospital, a nursing home, or the like, it is necessary to install many access points. The access points are typically positioned about every six to ten meters. Wiring an entire hospital or nursing home requires a very large number of access points and a corresponding number of electrical lines to connect each access point with the central unit. The access point modules are relatively expensive, an expense compounded by the cost of running a wire from each access point to the central unit.

The following contemplates new and improved methods and apparatuses that overcome the above-reverenced problems and others.

In accordance with one aspect, a wireless local area network is disclosed. A center access point is connected to a wired local area network. One or more remote access points communicate with the center access point via associated cables. A plurality of mobile wireless units is located within an access point network of the wireless local area network, each mobile wireless unit is configured to transceive with at least one of the center access point or one of the remote access points.

In accordance with another aspect, a communication method is disclosed. A center access point of a wireless local area network is connected to a wired local network. Remote access points are connected to the center access point with cables. Mobile wireless units are located within an access point network of the wireless local area network and configured to transceive with at least one of the center access point or one of the remote access points.

In accordance with another aspect, a communication system including a plurality of access point hubs is disclosed. Each access point hub includes a center access point which operates at a selected frequency or set of frequencies, and is connected to a central unit, and one or more remote access points which are connected to the center access point and operated by the center access point. Mobile wireless units are located within an access point network of the communication system, each mobile wireless unit transceives with at least one of the center access point or one of the remote access points.

In accordance with another aspect, a remote access point which is operated under control of a processor of a center access point is disclosed. The remote access point comprises at least first and second antennas, a first amplifier for amplifying signals received by one of the antennas, a second amplifier for amplifying signals to be transmitted by one of the antennas, an antenna selection switching assembly controlled by the center access point processor to select among the antennas, a transmit/receive switching assembly controlled by the center access point processor to select between transmit and receive modes, and a power circuit which distributes power from the center access point to the first and second amplifiers, the antenna select switching assembly, and the transmit/receive switching assembly.

Still further advantages and benefits of the present application will become apparent to those of ordinary skill in the art upon reading and understanding the following detailed description of the preferred embodiments.

The following may take form in various components and arrangements of components, and in various steps and arrangements of steps. The drawings are only for purposes of illustrating the preferred embodiments and are not to be construed as limiting the application.

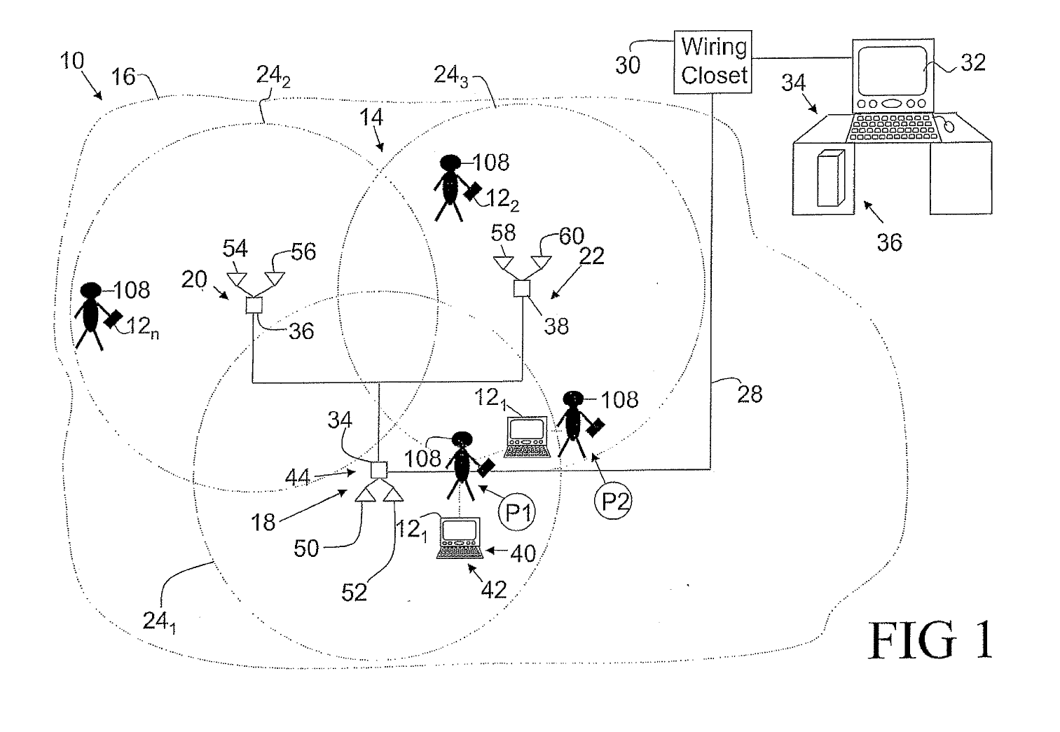

FIG. 1 schematically shows a portion of a WLAN communication system;

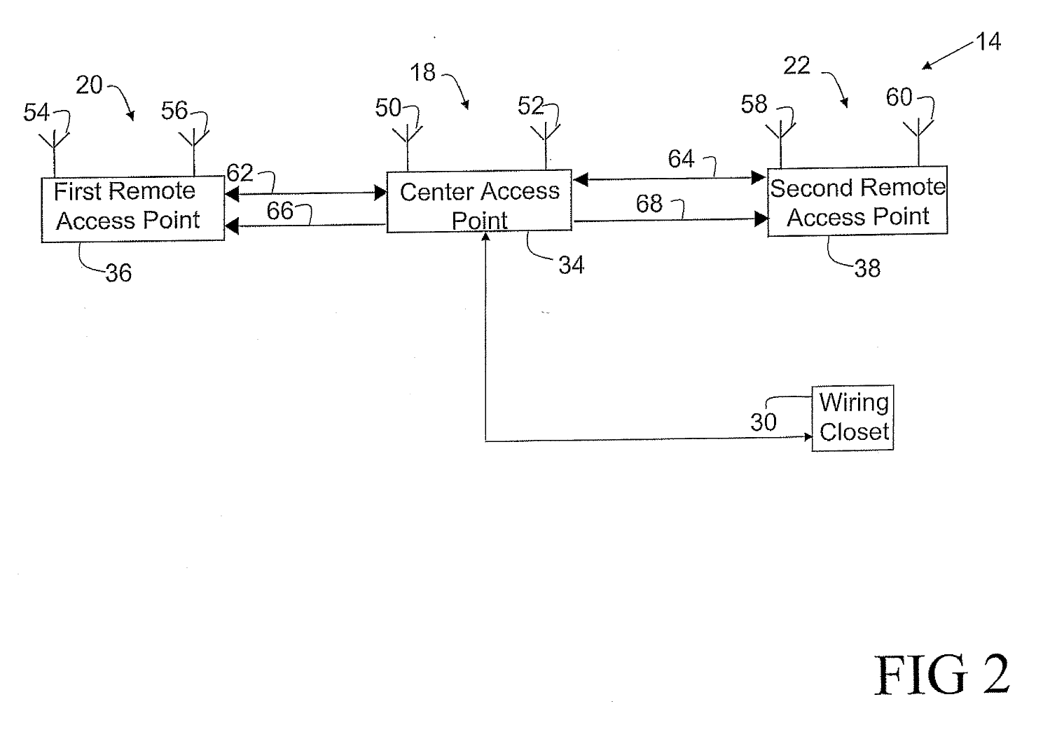

FIG. 2 schematically shows the center access point and two remote access points in a WLAN communication system; and

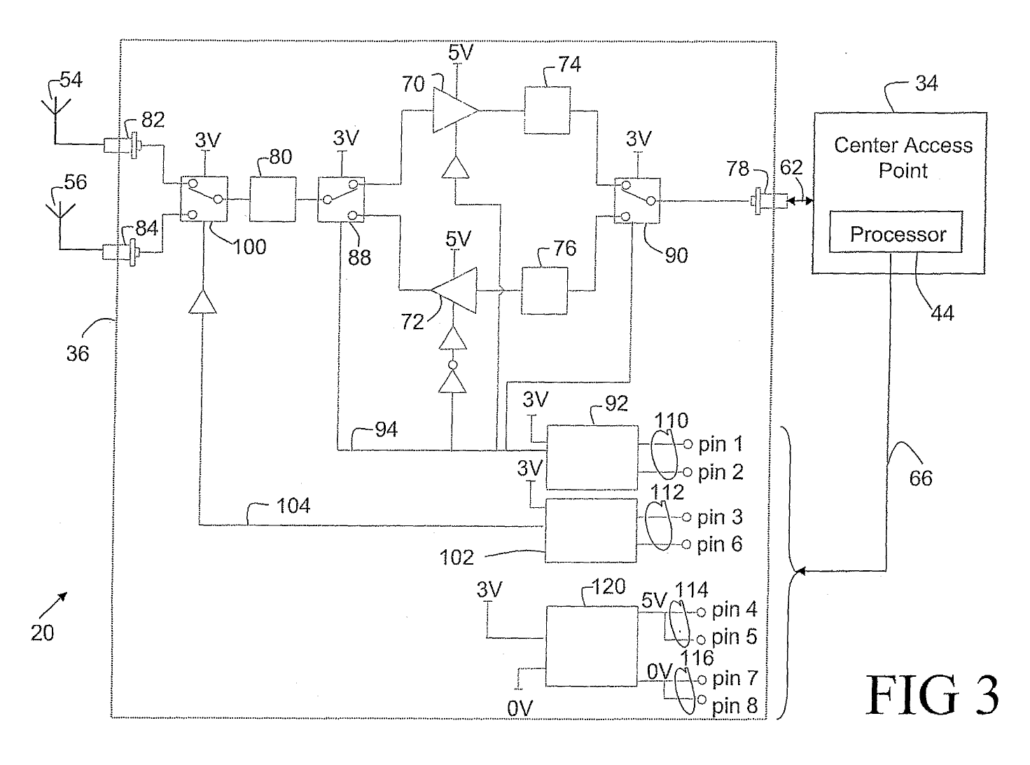

FIG. 3 schematically shows a detail of a remote access point in a WLAN communication system.

With reference to FIG. 1, a wireless local area network (WLAN) system 10 includes one or more mobile devices or units 12₁, 12₂, . . . , 12ₙ. For example, the mobile devices 12₁, 12₂, . . . , 12ₙ are telemetry or monitoring devices, which monitor pulse rate, blood oxygen, blood pressure, ECG signals or other telemetry data of patients, or devices such as palm computers, notebook computers, held-hand devices, PDAs, pagers, desktop computers, or any other devices which can be configured for wireless communications. The network 10 includes access point networks or hubs or access point network areas 14 (only one access point network is shown for simplicity of illustration), which are distributed throughout a defined area or space 16 to provide wireless service to the mobile devices 12₁, 12₂, . . . , 12ₙ, which operate within the defined space 16. Each access point network 14 includes a center or core station 18 including an antenna or antennas, a processor, and other associated circuitry and an associated remote station or stations such as illustrated first and second remote or auxiliary stations 20, 22 which each includes an antenna or antennas, amplifiers, and other associated circuitry. In the example of FIG. 1, the center station 18 and remote stations 20, 22 each includes two antennas for a diversity connection as described below. Each station 18, 20, 22 has a finite operational range or access point cell 24₁, 24₂, 24₃, which is typically 10-15 meters. The mobile devices 12₁, 12₂, . . . , 12ₙ communicate with the stations 18, 20, 22.

The center station 18 is wired or otherwise connected into a wired network infrastructure or a local area network, for example, via a wired connection 28 to a wiring closet 30, while the associated remote stations 20, 22 are wired or otherwise operationally connected to the center station 18. A central computer 32, which is connected to the local area network 30 and includes associated software means 34 and hardware means or processor 36, oversees the operations of the WLAN system 10 and, preferably, provides an interface to various systems and/or applications which are available within the local area network 30. The access point networks 14, for example, transmit the data monitored by the telemetry devices to the central computer 32. Each station 18, 20, 22 includes a corresponding receiving/transmitting means or receiver/transmitter or access point 34, 36, 38 to communicate bi-directionally with the mobile devices 12₁, 12₂, . . . , 12ₙ. E.g., the stations 18, 20, 22 at least receive, buffer, and transmit data between the mobile devices 12₁, 12₂, . . . , 12ₙ and the wired network. Each mobile medical monitor or other mobile device 12₁, 12₂, . . . , 12ₙ includes associated hardware means 40 and software means 42. The hardware and software means 40, 42 are implemented or integrated into the mobile devices 12₁, 12₂, . . . , 12ₙ to provide an interface between the mobile devices 12₁, 12₂, . . . , 12ₙ and the access points 34, 36, 38.

The center station 18 of each access point network 14 operates at a selected radio frequency or set of radio frequencies and includes associated hardware or processor 44 to control itself and the first and second remote stations 20, 22. Each access point network 14 has a fixed number of processing time slots, for example, thirty two slots and frequency channels, for example six frequencies. The time slots are allocated among the center station 18 and the remote stations 20, 22. For example, twelve slots are allocated to the center station 18, ten slots are allocated to the first remote station 20 and ten slots are allocated to the second station 22. The system services the center station antenna for a selected time, then each of the remote station antennas for a selected time. During transmit in any given time slot, the signal is transmitted only by one antenna of each access point network 14.

With continuing reference to FIG. 1 and further reference to FIG. 2, the center station 18 includes first and second antennas 50, 52, the first remote station 20 includes first and second antennas 54, 56, and the second remote station 22 includes first and second antennas 58, 60. The center access point 34 communicates with the first remote access point 36 via a bi-directional communication link or cable 62 and with the second remote access point 38 via a bidirectional communication link or cable 64. The bi-directional communication links 62, 64, for example, are carried out via RF coaxial communication cables. The center access point 34 supplies control signals and power to the first and second remote access points 36, 38 via a corresponding first or second link or cable 66, 68. The control signal and electric power, for example, are supplied via a cable which includes four pairs of twisted wires as described below.

With reference to FIG. 3, the first remote access point 36 includes a first or receive direction amplifier 70 and a second or transmit direction amplifier 72. The receive direction amplifier 70 and transmit direction amplifier 72 are operationally coupled to the center access point 34 via a respective first or second amplifier gain controller, such as an attenuator 74, 76 and a connector 78, such as a BNC connector. The receive direction amplifier 70 boosts the received signal up such that it has approximately the same signal strength level when it reaches the center access point 34 as a signal from one of the control access point antennas. Likewise, the transmit side amplifier 72 boosts the signal level higher so that the signal broadcast by the selected one of the remote access point antennas has approximately the same signal strength as a signal transmitted on one of the center access point antennas. In another embodiment, the transmit side amplifier 72 is implemented at the center station 18. In this manner, the amplifiers 70, 72 make up for the signal loss that occurs during signal reception/transmission in the cable 62.

The attenuators 74, 76 can be adjusted to control the gain of the amplifiers 70, 72. This allows to adjust the signal level of the signal transmitted from the center station 18 to the first remote station antennas 54, 56 at the same level as it had come from the center station 18. On the receive side, the signal is boosted to improve the reception of the antennas 50, 52 of the center station 18. The receive, transmit direction amplifiers 70, 72 is each connected to one of the first and second diversity antennas 54, 56 via a filter 80 and one of a respective first or second transmit connector 82, 84, such as a BNC connector. First and second transmit/receive direction switches 88, 90 are operationally coupled to a first receiver channel 92 of the first remote access point 36, to select one of the transmit and receive direction. More specifically, the first channel receiver 92, which is operationally coupled to the center access point 34, selects connection to one of the receive direction amplifier 70 or transmit direction amplifier 72 via an enable or first control line 94. A third or diversity switch 100 is operationally coupled to the antennas 54, 56 of the first remote station 20 and selects connection to one of the first remote station antennas 54, 56 to provide diversity reception and transmission. More specifically, a second receiver channel 102 of the first remote access point 36 is operationally coupled to the center access point 34 to select one of the first remote station antennas 54, 56 via a second or diversity control line 104.

The processor 44 of the center station 18 makes a diversity decision based on the received signal which is sought for on the same antenna which performed the transmission. Generally, the data packet that is sent over the wireless communication link includes a header. The processor 44 checks the signal strength during the header of the packet whilst selecting first one and then the other antennas. Based on the comparison, the processor 44 is able to determine which antenna is receiving better quality data, which, for example, is correlated to the result of the signal strength. For example, the indoor propagation contributes largely to the weak signal because of the multi-path fading. E.g., instead of the signal traveling straight from the transmitter to the receiver, the signal reflects from various structures within the building. Such reflection paths often cancel each other. If the receive signal is moved to a different antenna, the strength of the signal can be improved considerably. If the signals from the two antennas of the same station are insufficient for satisfactory reception, the system switches to another station as described below. Such antenna switching is, for example, performed prior to receiving the payload data portion of the packet.

In one embodiment, each mobile device 12₁, 12₂, . . . , 12ₙ includes a header which identifies the access point 34, 36, 38 with which the mobile device is registered. The mobile device senses the strongest signal and registers with the strongest signal carrying access point. The registration is performed by the center access point 34. Each access point 34, 36, 38 has an identifier that the mobile device 12₁, 12₂, . . . , 12ₙ can recognize. E.g., each access point 34, 36, 38 sends out a signal every frame. The mobile device 12₁, 12₂, . . . , 12ₙ receives the signal and, based on the signal strength, re-registers with the access point 34, 36, 38 with the strongest signal. Thus, for example, the mobile device 12₁ initially registered with the center station 18. As a user 108, associated with the mobile device 12₁, changes a user location from P1 to P2, the signal strength level of the center access point 34 becomes weaker, while the signal strength level of the second remote access point 36 becomes stronger. The mobile device 12₁ receives the stronger signal and re-registers with the second remote access point 36.

In this manner, the best antenna for communications with the mobile device 12₁, 12₂, . . . , 12ₙ is automatically selected by the center station 18 based on a quality of signal received by the receive channel. The transmit signal transmits on the selected antenna.

In one embodiment, the control signals communication and electric power supply between the center station 18 and remote station 20 is carried out via a cable which includes four twisted pairs. A first twisted pair 110 is connected to pins 1 and 2 to couple the center access point 34 and the first receiver channel 92 via a communication link, such as RS 485, to control the selection of the receive/transmit direction as described above. A second twisted pair 112 is connected to pins 3 and 4 to couple the center station access point 34 and the second receiver channel 102 via a communication link, such as RS 485, to control the first remote station antennas 54, 56 for diversity of reception and transmission as described above. Third and fourth twisted pairs 114, 116 supply electric power from the center station 18 to the remote station 20 and are coupled to pins 4, 5, 6, 8 of a power supply 120. The power supply 120 optionally includes a DC to DC converter to convert a received signal of about 5V, depending on cable attenuation, to a controlled 3V.

Because the access points in a hospital are typically applied along hallways, networks often expand in a one-dimensional manner. Placing the first remote access station 20 about six to ten meters in one direction down a hall from the center station 18 and the second remote station 22 about six to ten meters down the hall in the other direction cuts the wiring needs by two thirds and replaces two thirds of the conventional access points with lower cost remote access points.

The application has been described with reference to the preferred embodiments. Modifications and alterations will occur to others upon reading and understanding of the preceding detailed description. It is intended that the application be construed as including all such modifications and alterations insofar as they come within the scope of the appended claims or the equivalents thereof.

1. A wireless local area network comprising:
a center access point connected to a wired local network;
one or more remote access points which each communicates with the center access point via associated cables; and
a plurality of mobile wireless units located within an access point network of the wireless local area network, each mobile wireless unit is configured to transceive with at least one of the center access point and one of the remote access points.

2. The network as set forth in claim 1, wherein each access point includes associated first and second companion antennas for diversity reception/transmission.

3. The network as set forth in claim 2, wherein the center access point includes:
a processor which selects an antenna with a best signal to transceive with each mobile unit which selection is based on a strength of a signal received from the mobile unit.

4. The network as set forth in claim 3, wherein the center access point processor is programmed to perform steps of:
compare the strengths of the received signals from each antenna,
based on the comparison, select an antenna with the strongest signal reception, and
transmit signals to the mobile unit via the selected antenna.

5. The network as set forth in claim 2, wherein each access point includes:
an antenna switch controlled by the center access point for switching between the antennas of the remote access point.

6. The network as set forth in claim 1, wherein each of the center and remote access points is allocated a pre-selected set of time slots in which each one access point transmits and receives data without interference with the other access points in the access point network.

7. The network as set forth in claim 1, further including:
a transmit side amplifier which amplifies a signal transmitted from the center access point to the remote access point so that a transmitted signal strength level is substantially unchanged when the transmitted signal reaches the remote access point.

8. The network as set forth in claim 7, wherein the transmit side amplifier is disposed at the remote access point.

9. The network as set forth in claim 7, further including:
a receive side amplifier which amplifies a signal received by the remote access point from the mobile unit.

10. The network as set forth in claim 1, wherein each remote access point includes:
at least one amplifier for amplifying at least one of transmitted and received signals; and
a switch assembly controlled by the center access point to switch between a transmit mode, in which signals from the center access point are transmitted, and a receive mode, in which received signals are received and sent to the center access point.

11. The network as set forth in claim 10, wherein each remote access point further includes:
a power circuit which receives power over one of the associated cables from the center access point and distributes the power to the amplifiers and other components of the remote access point.

12. A remote access point for connection to the center access point of the network of claim 1.

13. A communication method comprising:
connecting a center access point of a wireless local area network to a wired local network;
connecting remote access points to the center access point with cables; and
configuring mobile wireless units located within an access point network of the wireless local area network to transceive with at least one of the center access point and one of the remote access points.

14. The method as set forth in claim 13, wherein each access point includes at least first and second companion antennas for diversity reception/transmission, the method further including:
selecting among the antennas of the center and remote access points.

15. The method as set forth in claim 14, further including:
receiving signals with the selected antenna;
sending data from the received signals over the wired network with the center access point; and
transmitting signals from the center access point to the mobile unit via the selected antenna.

16. The method as set forth in claim 13, further including:
amplifying a signal transmitted by the center access point to the remote access point with a first amplifier so that a transmitted signal strength level applied to an antenna of the remote access point is essentially the same as the signal strength level of the signal applied to an antenna of the center access point.

17. The method as set forth in claim 16, further including:
amplifying a signal received by the remote access point from the mobile unit with a second amplifier; and
communicating the amplified signal by the cable to the center access point, the amplification being such that the amplified signal received at the center access point is substantially the same signal level as the signal received by the remote access point antenna.

18. The method as set forth in claim 17, further including:
switching between a transmit mode, in which signals from the center access point are transmitted, and a receive mode, in which signals are sent to the center access point, with a switching mechanism.

19. The method as set forth in claim 18, further including:
receiving power over one of the associated cables from the center access point at the remote access point; and
distributing the power to at least the first and second amplifiers and the switching mechanism of the remote access point.

20. A communication system comprising:
a plurality of access point hubs, each including:
a center access point which operates at a dedicated frequency and is connected to a central unit, and
one or more remote access points which are connected to the center access point and operated by the center access point; and
mobile wireless units located within an access point network of the communication system, each mobile wireless unit is configured to transceive with at least one of the center access point and one of the remote access points.

21. The system as set forth in claim 20, further including:
a transmit side amplifier which amplifies a signal transmitted from the center access point to the remote access point so that a transmitted signal strength level is substantially unchanged when the transmitted signal reaches the remote access point; and
a receive side amplifier which amplifies a signal received by the remote access point from the mobile unit so that a received signal strength level is substantially unchanged when the received signal reaches the center access point, wherein the transmit and receive side amplifiers cooperate to make up for a signal loss in cables by which the signal transverses between center access point and a corresponding remote access point.

22. The system as set forth in claim 20, wherein each access point includes first and second antennas for diversity reception/transmission, and the center access point includes:
a processor which selects an antenna with a best signal strength level based on a strength of a signal received from the mobile unit.

23. A remote access point which is operated under control of a processor of a center access point, the remote access point comprising:
at least first and second antennas;
a first amplifier for amplifying signals received by one of the antennas;
a second amplifier for amplifying signals to be transmitted by one of the antennas;
an antenna selection switching assembly controlled by the center access point processor to select among the antennas;
a transmit/receive switching assembly controlled by the center access point processor to select between transmit and receive modes; and
a power circuit which distributes power from the center access point to the first and second amplifiers, the antenna select switching assembly, and the transmit/receive switching assembly.
